(19) United States
(12) Patent Application Publication
(10) Pub. No.: US 2012/0226981 A1
(43) Pub. Date: Sep. 6, 2012

(54) CONTROLLING ELECTRONIC DEVICES IN A MULTIMEDIA SYSTEM THROUGH A NATURAL USER INTERFACE

(75) Inventor: John Clavin, Seattle, WA (US)

(73) Assignee: MICROSOFT CORPORATION, Redmond, WA (US)

(21) Appl. No.: 13/039,024

(22) Filed: Mar. 2, 2011

(51) Int. Cl. G06F 3/033; G06F 3/048

(52) U.S. Cl. 715/719; 715/863; 715/750; 715/716; 704/E11.001

(57) ABSTRACT

Technology is provided for controlling one or more electronic devices networked in a multimedia system using a natural user interface. Some examples of devices in the multimedia system are audio and visual devices for outputting multimedia content to a user like a television, a video player, a stereo, speakers, a music player, and a multimedia console computing system. A computing environment is communicatively coupled to a device for capturing data of a physical action, like a sound input or gesture, from a user which represents a command. Software executing in the environment determines for which device a user command is applicable and sends the command to the device. In one embodiment, the computing environment communicates commands to one or more devices using a Consumer Electronics Channel (CEC) of an HDMI connection.

### BACKGROUND

In a typical home, there are often several electronic devices connected together in a multimedia system which output audio, visual or audiovisual content. An example of such devices are entertainment devices of a home theatre or entertainment system. Some examples of these devices are a television, a high definition display device, a music player, a stereo system, speakers, a satellite receiver, a set-top box, and a game console computer system. Typically, such devices are controlled via buttons on one or more hand-held remote controllers.

### SUMMARY

The technology provides for controlling one or more electronic devices in a multimedia system using a natural user interface. Physical actions of a user, examples of which are sounds and gestures, are made by a user's body, and may represent commands to one or more devices in a multimedia system. A natural user interface comprises a capture device communicatively coupled to a computing environment. The capture device captures data of a physical action command, and the computing environment interprets the command and sends it to the appropriate device in the system. In some embodiments, the computing environment communicates with the other electronic devices in the multimedia system over a command and control channel, one example of which is a high definition multimedia interface (HDMI) consumer electronics channel (CEC).

In one embodiment, the technology provides a computer implemented method for controlling one or more electronic devices in a multimedia system using a natural user interface of another device comprising sensing one or more physical actions of a user by the natural user interface. The method further comprises identifying a device command for at least one other device by a first electronic device from data representing the one or more physical actions, and the first device sending the command to the at least one other electronic device.

In another embodiment, the technology provides a multimedia system comprising a capture device for capturing data of a physical action of a user indicating a command to one or more electronic devices in the multimedia system and a computing environment. The computing environment comprises a processor and a memory and is communicatively coupled to the capture device to receive data indicating the command. One or more other devices in the multimedia system are in communication with the computing environment. The computing environment further comprises software executable by the processor for determining for which of the one or more other devices the command is applicable and sending the command to the applicable device. Additionally, the computing environment comprises user recognition software for identifying a user based on data representing one or more physical characteristics captured by the capture device. The data representing one or more physical characteristics may be sound data, image data or both.

In another embodiment, a computer readable storage medium has stored thereon instructions for causing one or more processors to perform a computer implemented method for controlling one or more electronic devices in a multimedia system using a natural user interface. The method comprises receiving a device command by a first electronic device for at least one other device in the multimedia system and detecting one or more users in data captured via the natural user interface. One or more of the detected users are identified including the user making the command. A determination is made as to whether the user making the command has priority over other detected users. Responsive to the user making the command having priority over other detected users, sending the command to the at least one other electronic device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A and 1B illustrate an embodiment of a target recognition, analysis, and tracking system with a user playing a game.

FIG. 2 illustrates an embodiment of a system for controlling one or more electronic devices in a multimedia system using a natural user interface of another device.

FIG. 3A illustrates an embodiment of a computing environment that may be used to interpret one or more physical actions in a target recognition, analysis, and tracking system.

FIG. 3B illustrates another embodiment of a computing environment that may be used to interpret one or more physical actions in a target recognition, analysis, and tracking system.

FIG. 4 illustrates an embodiment of a multimedia system that may utilize the present technology.

FIG. 5 illustrates an exemplary set of operations performed by the disclosed technology to automatically activate a computing environment in a multimedia system through user interaction.

FIG. 6 is a flowchart of an embodiment of a method for a computing environment registering one or more devices in a multimedia system for receiving commands.

FIG. 7 is a flowchart of an embodiment of a method for controlling one or more electronic devices in a multimedia system using a natural user interface.

FIG. 8 is a flowchart of an embodiment of a method for determining whether a second device is used to process a command for a first device.

FIG. 9 is a flowchart of an embodiment of a method for executing a command in accordance with user preferences.

FIG. 10 is a flowchart of an embodiment of a method for requesting a display of a command history.

### DETAILED DESCRIPTION

Technology is disclosed by which other electronic devices may receive commands indicated by physical actions of a user captured through a natural user interface of another device in a multimedia system. An example of a multimedia system is a home audiovisual system of consumer electronics like televisions, DVD players, and stereos which output audio and visual content. The devices in the system communicate via a command and control protocol. In one embodiment, each of the devices has an HDMI hardware chip for enabling an HDMI connection, wired or wireless, which includes a consumer electronics channel (CEC). On the CEC channel, standardized codes for commands to devices are used to communicate user commands. The computing environment may also automatically send commands to other devices which help fulfill or process the command received from a user for a first device. For example, a command to turn-on a digital video recorder (DVR) or a satellite receiver may be received. Software executing in the computing environment also determines whether the television is on, and if not, turns on the television. Furthermore, the software may cause the television channel to be set to the channel for which output from the DVR or satellite receiver is displayed.

Besides communicating commands to other devices, some embodiments provide for storing a history of commands along with time records of the date and time of the commands. Other embodiments further take advantage of image recognition or voice recognition or both to identify users and their preferences for operation of the devices in the system as can be controlled by commands. Additionally, identification of users allows for a priority scheme between users for control of the electronic devices.

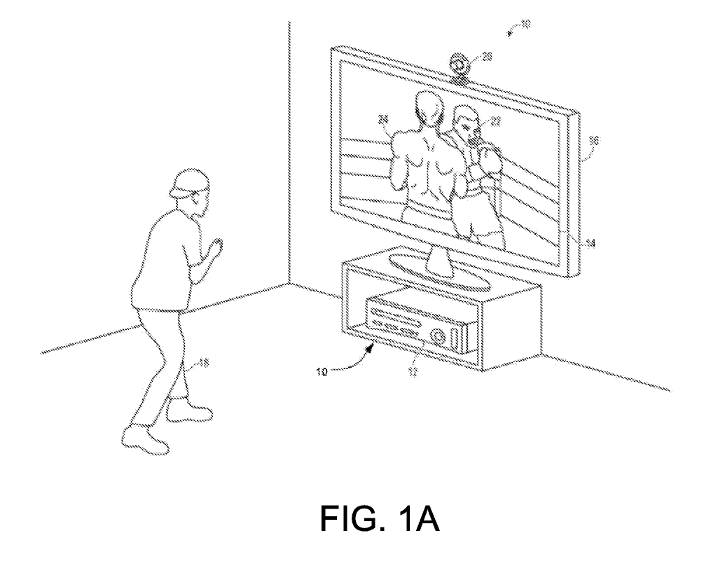

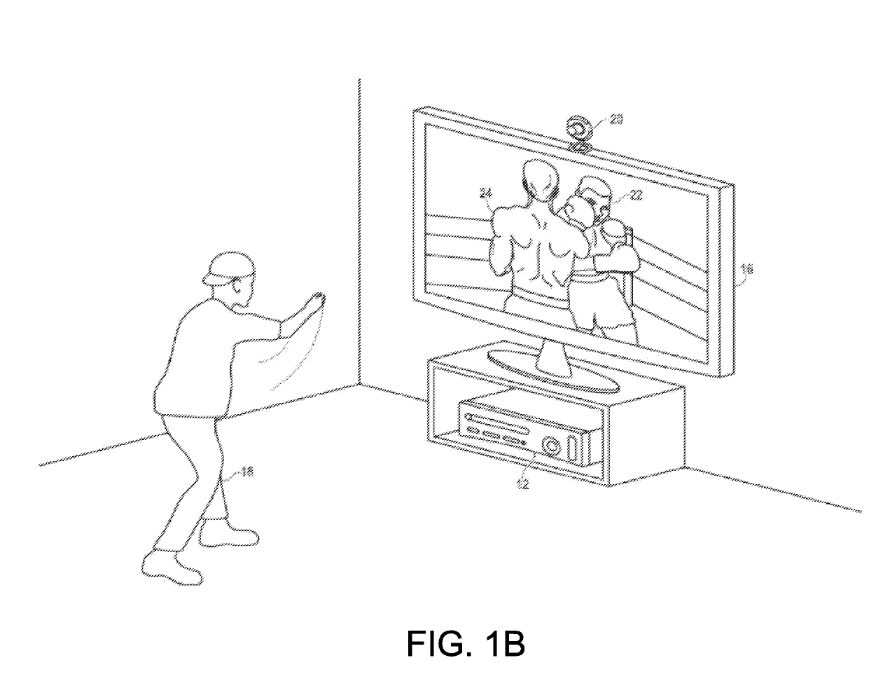

FIGS. 1A-2 illustrate a target recognition, analysis, and tracking system 10 which may be used by the disclosed technology to recognize, analyze, and/or track a human target such as a user 18. Embodiments of the target recognition, analysis, and tracking system 10 include a computing environment 12 for executing a gaming or other application, and an audiovisual device 16 for providing audio and visual representations from the gaming or other application. The system 10 further includes a capture device 20 for detecting gestures of a user captured by the device 20, which the computing environment receives and uses to control the gaming or other application. Furthermore, the computing environment can interpret gestures which are device commands. As discussed below, the target recognition, analysis, and tracking system 10 may also include a microphone as an audio capture device for detecting speech and other sounds which may also indicate a command, alone or in combination with a gesture. Each of these components is explained in greater detail below.

As shown in FIGS. 1A and 1B, in an example, the application executing on the computing environment 12 may be a boxing game that the user 18 may be playing. For example, the computing environment 12 may use the audiovisual device 16 to provide a visual representation of a boxing opponent 22 to the user 18. The computing environment 12 may also use the audiovisual device 16 to provide a visual representation of a player avatar 24 that the user 18 may control with his or her movements. For example, as shown in FIG. 1B, the user 18 may throw a punch in physical space to cause the player avatar 24 to throw a punch in game space. Thus, according to an example embodiment, the computer environment 12 and the capture device 20 of the target recognition, analysis, and tracking system 10 may be used to recognize and analyze the punch of the user 18 in physical space such that the punch may be interpreted as a game control of the player avatar 24 in game space.

Other movements by the user 18 may also be interpreted as other controls or actions, such as controls to bob, weave, shuffle, block, jab, or throw a variety of different power punches. Moreover, as explained below, once the system determines that a gesture is one of a punch, bob, weave, shuffle, block, etc., additional qualitative aspects of the gesture in physical space may be determined. These qualitative aspects can affect how the gesture (or other audio or visual features) are shown in the game space as explained hereinafter.

In example embodiments, the human target such as the user 18 may have an object. In such embodiments, the user of an electronic game may be holding the object such that the motions of the player and the object may be used to adjust and/or control parameters of the game, or an electronic device in the multimedia system. For example, the motion of a player holding a racket may be tracked and utilized for controlling an on-screen racket in an electronic sports game. In another example embodiment, the motion of a player holding an object may be tracked and utilized for controlling an on-screen weapon in an electronic combat game.

FIG. 2 illustrates an embodiment of a system for controlling one or more electronic devices in a multimedia system using a natural user interface of another device. In this embodiment, the system is a target recognition, analysis, and tracking system 10. According to an example embodiment, a capture device 20 may be configured to capture video with depth information including a depth image that may include depth values via any suitable technique including, for example, time-of-flight, structured light, stereo image, or the like. In other embodiments, gestures for device commands may be determined from two-dimensional image data.

As shown in FIG. 2, the capture device 20 may include an image camera component 22, which may include an IR light component 24, a three-dimensional (3-D) camera 26, and an RGB camera 28 that may be used to capture the depth image of a scene. The depth image may include a two-dimensional (2-D) pixel area of the captured scene where each pixel in the 2-D pixel area may represent a length in, for example, centimeters, millimeters, or the like of an object in the captured scene from the camera.

For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28. According to another embodiment, the capture device 20 may include two or more physically separated cameras that may view a scene from different angles, to obtain visual stereo data that may be resolved to generate depth information.

In one embodiment, the capture device 20 may include one or more sensors 36. One or more of the sensors 36 may include passive sensors such as, for example, motion sensors, vibration sensors, electric field sensors or the like that can detect a user's presence in a capture area associated with the computing environment 12 by periodically scanning the capture area. For a camera, its capture area may be a field of view. For a microphone, its capture area may be a distance from the microphone. For a sensor, its capture area may be a distance from a sensor, and there may be a directional area associated with a sensor or microphone as well. The sensors, camera, and microphone may be positioned with respect to the computing environment to sense a user within a capture area, for example within distance and direction boundaries, defined for the computing environment. The capture area for the computing environment may also vary with the form of physical action used as command and sensing capture device. For example, a voice or sound command scheme may have a larger capture area as determined by the sensitivity of the microphone and the fact that sound can travel through walls. The passive sensors may operate at a very low power level or at a standby power level to detect a user's presence in the capture area, thereby enabling the efficient power utilization of the components of the system.

Upon detecting a user's presence, one or more of the sensors 36 may be activated to detect a user's intent to interact with the computing environment. In one embodiment, a user's intent to interact with the computing environment 12 may be detected based on a physical action like an audio input such as a clapping sound from the user, lightweight limited vocabulary speech recognition, or lightweight image processing, such as, for example, a 1 HZ rate look for a user standing in front of the capture device 20 or facing the capture device 20. Based upon data of the physical action indicating the user's intent to interact, the power level of the computing environment 12 may be automatically varied and the computing environment 12 may be activated for the user, for example by changing a power level from a standby mode to an active mode. The operations performed by the disclosed technology are discussed in greater detail in the process embodiments discussed below.

The capture device 20 may further include a microphone 30. The microphone 30 may include a transducer or sensor that may receive and convert sound into an electrical signal which may be stored as processor or computer readable data. The microphone 30 may be used to receive audio signals provided by the user for device command or to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image capture component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and a skeletal model that may be generated by the capture device 20 to the computing environment 12 via the communication link 36. The computing environment 12 may then use the skeletal model, depth information, and captured images to recognize a user and user gestures for device commands or application controls.

As shown, in FIG. 2, the computing environment 12 may include a gesture recognition engine 190. The gesture recognition engine 190 may be implemented as a software module that includes executable instructions to perform the operations of the disclosed technology. The gesture recognition engine 190 may include a collection of gesture filters 46, each comprising information concerning a gesture that may be performed by the skeletal model which may represent a movement or pose performed by a user's body. The data captured by the cameras 26, 28 of capture device 20 in the form of the skeletal model and movements and poses associated with it may be compared to gesture filters 46 in the gesture recognition engine 190 to identify when a user (as represented by the skeletal model) has performed one or more gestures. Those gestures may be associated with various controls of an application and device commands. Thus, the computing environment 12 may use the gesture recognition engine 190 to interpret movements or poses of the skeletal model and to control an application or another electronic device 45 based on the movements or poses. In an embodiment, the computing environment 12 may receive gesture information from the capture device 20 and the gesture recognition engine 190 may identify gestures and gesture styles from this information.

One suitable example of tracking a skeleton using depth image is provided in U.S. patent application Ser. No. 12/603,437, “Pose Tracking Pipeline” filed on Oct. 21, 2009, Craig, et al. (hereinafter referred to as the '437 application), incorporated herein by reference in its entirety. Suitable tracking technologies are also disclosed in the following four U.S. patent applications, all of which are incorporated herein by reference in their entirety: U.S. patent application Ser. No. 12/475,308, “Device for Identifying and Tracking Multiple Humans Over Time,” filed on May 29, 2009; U.S. patent application Ser. No. 12/696,282, “Visual Based Identity Tracking,” filed on Jan. 29, 2010; U.S. patent application Ser. No. 12/641,788, “Motion Detection Using Depth Images,” filed on Dec. 18, 2009; and U.S. patent application Ser. No. 12/575,388, “Human Tracking System,” filed on Oct. 7, 2009.

More information about embodiments of the gesture recognition engine 190 can also be found in U.S. patent application Ser. No. 12/422,661, “Gesture Recognizer System Architecture,” filed on Apr. 13, 2009, incorporated herein by reference in its entirety. More information about recognizing gestures can also be found in the following U.S. patent applications, all of which are incorporated herein by reference in their entirety: U.S. patent application Ser. No. 12/391,150, “Standard Gestures,” filed on Feb. 23, 2009; U.S. patent application Ser. No. 12/474,655, “Gesture Tool” filed on May 29, 2009; and U.S. patent application Ser. No. 12/642,589, filed Dec. 18, 2009.

One or more sounds sensed by the microphone 30 may be sent by the processor 32 in a digital format to the computing environment 12 which sound recognition software 194 processes for identifying among other things voice or other sounds which are for device commands.

The computing environment further comprises user recognition software 196 which identifies a user detected by the natural user interface. The user recognition software 196 may identify a user based on physical characteristics captured by the capture device in a capture area. In some embodiments, the user recognition software 196 recognizes a user from sound data, for example, using voice recognition data. In some embodiments, the user recognition software 196 recognizes users from image data. In other embodiments, the user recognition software 196 bases identification on sound, image and other data available like login credentials for making user identifications.

For the identification of a user based on image data, the user recognition software 196 may correlate a user's face from the visual image received from the capture device 20 with a reference visual image which may be stored in a filter 46 or in user profile data 40 to determine the user's identity. In some embodiments, an image capture device captures two dimensional data, and the user recognition software 196 performs face detection on the image and facial recognition techniques for any faces identified. For example, in a system using sound commands for controlling devices, detection of users may also be performed based on image data available of a capture area.

In some embodiments, the user recognition software associates a skeletal model for tracking gestures with a user. For example, a skeletal model is generated for each human-like shape detected by software executing on the processor 32. An identifier for each generated skeletal model may be used to track the respective skeletal model across software components. The skeletal model may be tracked to a location within an image frame, for example pixel locations. The head of the skeletal model may be tracked to a particular location in the image frame, and visual image data from the frame at that particular head location may be compared or analyzed against the reference image for face recognition. A match with a reference image indicates that skeletal model represents the user whose profile includes the reference image. The user's skeletal model may also be used for indentifying user characteristics, for example the height and shape of the user A reference skeletal model of the user may be in the user's profile data and used for comparison. In one example, the user recognition software 196 sends a message to the device controlling unit 540 including a user identifier and skeletal model identifier and which message indicates the identified skeletal model is the identified user. In other examples, the message may also be sent to the gesture recognition software 190 which may send a message with notice of a command gesture to the device controlling unit 540 which includes the user identifier as well.

For detected users for whom a user profile is not available, the user recognition software 196 may store image data and/or sound data of the unidentified user and provide a user identifier for tracking the unidentified individual in captured data.

In one embodiment of creating user identification data, users may be asked to identify themselves by standing in front of the computing system 12 so that the capture device 20 may capture depth images and visual images for each user. For example, a user may be asked to stand in front of the capture device 20, turn around, and make various poses. After the computing system 12 obtains data which may be used as a basis to identify a user, the user is provided with a user identifier and password identifying the user. More information about identifying users can be found in U.S. patent application Ser. No. 12/696,282, “Visual Based Identity Tracking” and U.S. patent application Ser. No. 12/475,308, “Device for Identifying and Tracking Multiple Humans over Time,” both of which are incorporated herein by reference in their entirety.

In embodiments using voice commands, or sounds made by a human voice, a sound or voice reference file may be created for a user. The user recognition software 196 may perform voice recognition at the request of the sound recognition software 194 when that software 194 identifies a command. The user recognition software 196 returns a message indicating an identifier for the user based on the results of the voice recognition techniques, for example a comparison with a reference sound file in user profile data 40. Again, if there is not a match in the sound files of user profile data 40, the command may be stored as a sound file and associated with an assigned identifier for this unknown user. The commands of the unknown user can therefore be tracked.

In some embodiments, during a set-up, sound recording files of different users speaking commands may be recorded and stored in user profile data 40. The sound recognition software 194 may use these files as references for determining voice commands, and when a match occurs, the sound recognition software sends a message to the device controlling unit 540 including a user identifier associated with the reference file (e.g. in file meta data). For unidentified users, the sound recognition software 194 may send a request to the user recognition software 196 which can set-up an identifier for the unknown user as mentioned above. Additionally, the user recognition software 196 may perform voice recognition as requested for identifying users who are detected in the capture area but who are not issuing commands.

In some embodiments, the user's identity may be also determined based on input data from the user like login credentials via one or more user input devices 48. Some examples of user input devices are a pointing device, a game controller, a keyboard, or a biometric sensing system (e.g. fingerprint or iris scan verification system). A user may login using a game controller and the user's skeletal and image data captured during login is associated with those user login credentials thereafter as the user's gestures control one or more devices or applications.

User profile data 40 stored in a memory of the computing environment 12 may include information about the user such as a user identifier and password associated with the user, the user's name, and other demographic information related to the user. In some examples, user profile data 40 may also store or store associations to storage locations for one or more of the following for identification of the user: image, voice, biometric and skeletal model data.

The above examples for identifying a user and associating the user with command data are just some illustrative examples of many implementation examples.

As further illustrated in FIG. 2, the computing environment may also include a device controlling unit 540. In one implementation, the device controlling unit 540 may be a software module that includes executable instructions for controlling one or more electronic devices 45 in a multimedia system communicatively coupled to the computing environment 12. In an embodiment, the device controlling unit 540 may receive a notification or message from the sound recognition software 194, the gesture recognition engine 190, or both that a physical action of a sound (i.e. voice) input and/or a device command gesture has been detected. The device controlling unit 540 may also receive a message or other notification from the one or more sensors 36 via the processor 32 to the computing environment 12 that a user's presence has been sensed within a field of view of the image capture device 20, so the unit 540 may adjust the power level of the computing environment 12 and the capture device 20 to receive commands indicated by the user's physical actions.

The device controlling unit 540 accesses a device data store 42 which stores device and command related data. For example, it stores which devices are in the multimedia system, operational status of devices, the command data set for each device including the commands the respective device processes. In some examples, the device data store 42 stores a lookup table or other association format of data identifying which devices support processing of which commands for other devices. For example, the data may identify which devices provide input or output of content for each respective device. For example, television display 16 outputs content by displaying the movie data played by a DVD player. Default settings for operation of devices may be stored and any other data related to operation and features of the devices may also be stored.

In some embodiments, a memory of the computing environment 12 stores command history data which tracks data related to the device commands such as when device commands were received, the user who made a command, users detected in a capture area of the capture device when the command was made, for which device a command was received, time and date of the command, and also an execution status of the command. Execution status may include whether the command was not executed and perhaps a reason if the device effected provides an error description in a message.

As discussed further below, in some embodiments, the device controlling unit 540 stores device preferences for one or more users in user profile data 40 or the device data 42 or some combination of the two data stores. An example of device preferences are volume or channel settings, for example for the television or the stereo. Another example, is a preference for one content input or output device which works with another device to fulfill or process a command to the other device. As an example of a content input device, a user may prefer to listen to an Internet radio or music website rather than the local broadcast stations. The device controlling unit 540 turns on an Internet router to facilitate locating the Internet radio “station.” For another user who prefers the local broadcast stations, the device controlling unit 540 does not turn on the router. In another example, one user may prefer to view content on the television display while the audio of the content is output through speakers of a networked stereo system, so the device controlling unit 540 turns on the stereo as well and sends a command to the stereo to play the content on a port which receives the audio output from the audiovisual TV display unit 16. The preferences may be based on monitoring the settings and supporting devices used by the one or more users over time and determining which settings and supporting devices are used most often by the user when giving commands for operation of a device.

Some of the operations which may be performed by the device controlling unit 540 will be discussed in greater detail in the process figures below.

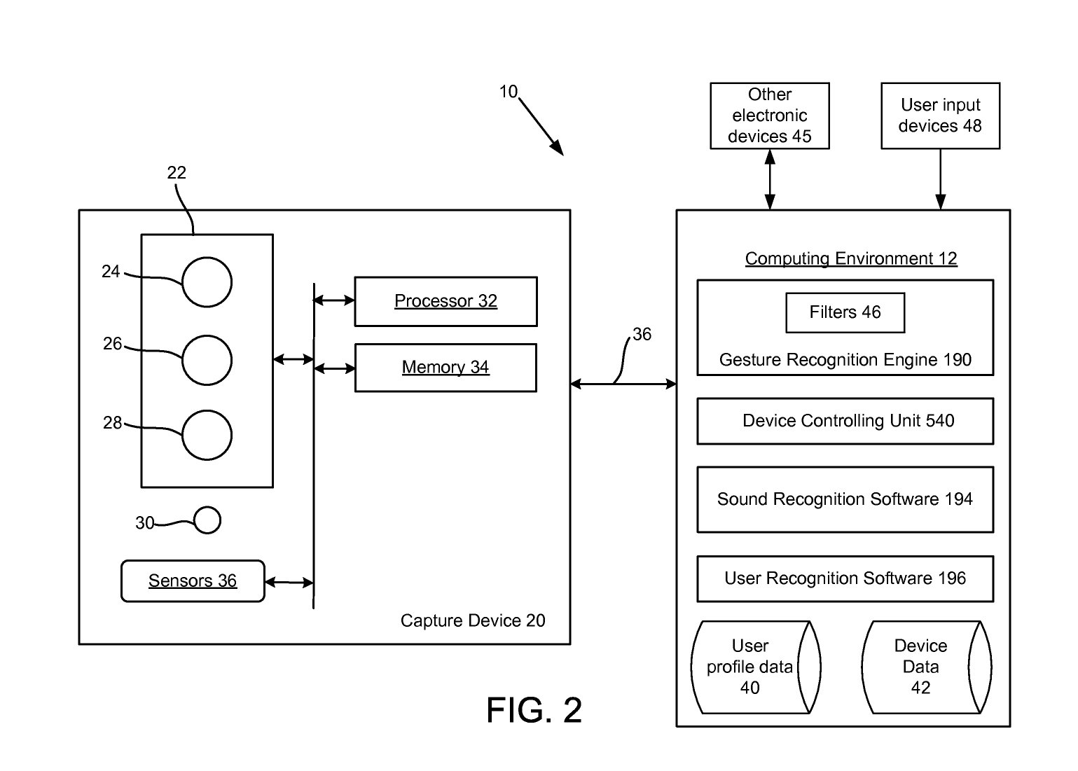

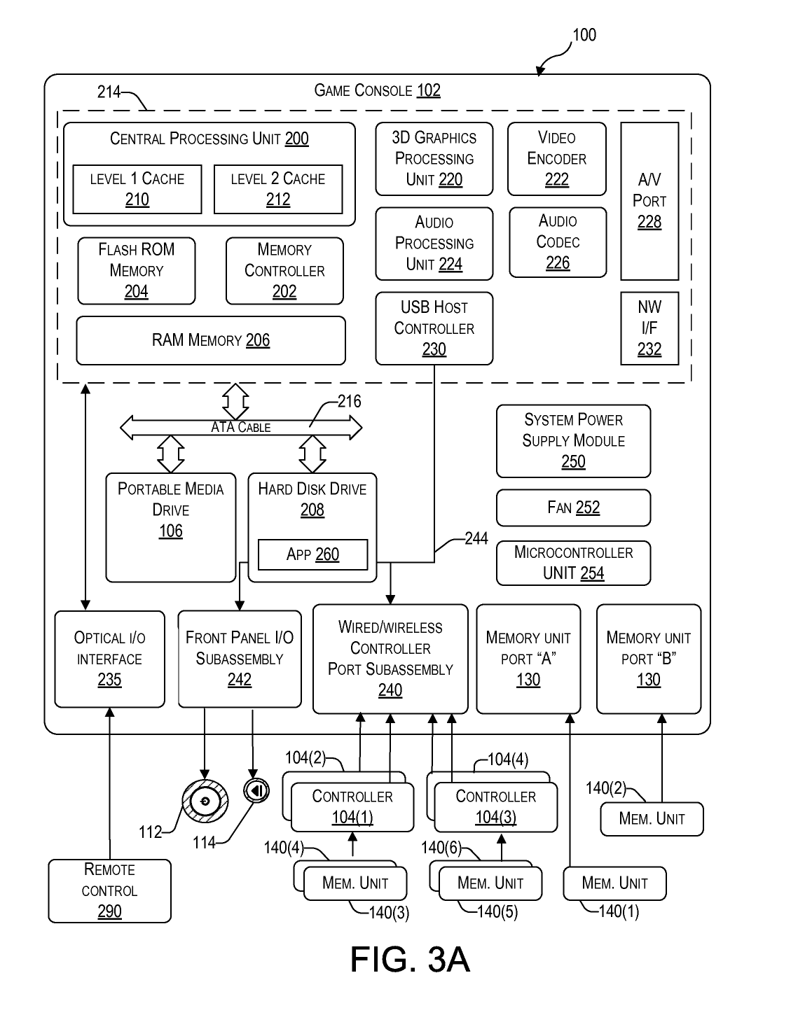

FIG. 3A illustrates an embodiment of a computing environment that may be used to interpret one or more physical actions in a target recognition, analysis, and tracking system. The computing environment such as the computing environment 12 described above with respect to FIGS. 1A-2 may be a multimedia console 102, such as a gaming console. Console 102 has a central processing unit (CPU) 200, and a memory controller 202 that facilitates processor access to various types of memory, including a flash Read Only Memory (ROM) 204, a Random Access Memory (RAM) 206, a hard disk drive 208, and portable media drive 106. In one implementation, CPU 200 includes a level 1 cache 210 and a level 2 cache 212, to temporarily store data and hence reduce the number of memory access cycles made to the hard drive 208, thereby improving processing speed and throughput.

CPU 200, memory controller 202, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 200, memory controller 202, ROM 204, and RAM 206 are integrated onto a common module 214. In this implementation, ROM 204 is configured as a flash ROM that is connected to memory controller 202 via a PCI bus and a ROM bus (neither of which are shown). RAM 206 is configured as multiple Double Data Rate Synchronous Dynamic RAM (DDR SDRAM) modules that are independently controlled by memory controller 202 via separate buses (not shown). Hard disk drive 208 and portable media drive 106 are shown connected to the memory controller 202 via the PCI bus and an AT Attachment (ATA) bus 216. However, in other implementations, dedicated data bus structures of different types can also be applied in the alternative.

A three-dimensional graphics processing unit 220 and a video encoder 222 form a video processing pipeline for high speed and high resolution (e.g., High Definition) graphics processing. Data are carried from graphics processing unit 220 to video encoder 222 via a digital video bus (not shown). An audio processing unit 224 and an audio codec (coder/decoder) 226 form a corresponding audio processing pipeline for multi-channel audio processing of various digital audio formats. Audio data are carried between audio processing unit 224 and audio codec 226 via a communication link (not shown). The video and audio processing pipelines output data to an A/V (audio/video) port 228 for transmission to a television or other display. In the illustrated implementation, video and audio processing components 220-228 are mounted on module 214.

FIG. 3A shows module 214 including a USB host controller 230 and a network interface 232. USB host controller 230 is shown in communication with CPU 200 and memory controller 202 via a bus (e.g., PCI bus) and serves as host for peripheral controllers 104(1)-104(4). Network interface 232 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 3A, console 102 includes a controller support subassembly 240 for supporting four controllers 104(1)-104(4). The controller support subassembly 240 includes any hardware and software components needed to support wired and wireless operation with an external control device, such as for example, a media and game controller. A front panel I/O subassembly 242 supports the multiple functionalities of power button 112, the eject button 114, as well as any LEDs (light emitting diodes) or other indicators exposed on the outer surface of console 102. Subassemblies 240 and 242 are in communication with module 214 via one or more cable assemblies 244. In other implementations, console 102 can include additional controller subassemblies. The illustrated implementation also shows an optical I/O interface 235 that is configured to send and receive signals that can be communicated to module 214.

Memory Units (MUs) 140(1) and 140(2) are illustrated as being connectable to MU ports “A” 130(1) and “B” 130(2) respectively. Additional MUs (e.g., MUs 140(3)-140(6)) are illustrated as being connectable to controllers 104(1) and 104(3), i.e., two MUs for each controller. Controllers 104(2) and 104(4) can also be configured to receive MUs (not shown). Each MU 140 offers additional storage on which games, game parameters, and other data may be stored. In some implementations, the other data can include any of a digital game component, an executable gaming application, an instruction set for expanding a gaming application, and a media file. When inserted into console 102 or a controller, MU 140 can be accessed by memory controller 202. A system power supply module 250 provides power to the components of gaming system 100. A fan 252 cools the circuitry within console 102.

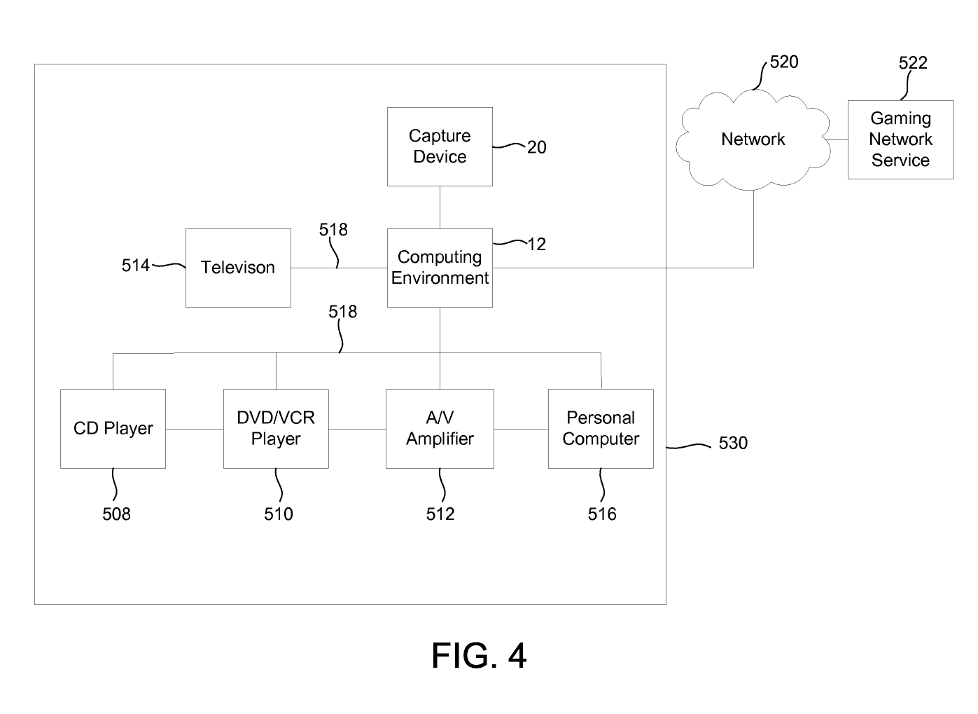

In an embodiment, console 102 also includes a microcontroller unit 254. The microcontroller unit 254 may be activated upon a physical activation of the console 102 by a user, such as for example, by a user pressing the power button 112 or the eject button 114 on the console 102. Upon activation, the microcontroller unit 254 may operate in a very low power state or in a standby power state to perform the intelligent power control of the various components of the console 102, in accordance with embodiments of the disclosed technology. For example, the microcontroller unit 254 may perform intelligent power control of the various components of the console 102 based on the type of functionality performed by the various components or the speed with which the various components typically operate. In another embodiment, the microcontroller unit 254 may also activate one or more of the components in the console 102 to a higher power level upon receiving a console device activation request, in the form of a timer, a remote request or an offline request by a user of the console 102 or responsive to a determination a user intends to interact with the console 102 (See FIG. 5, for example). Or, the microcontroller unit 254 may receive a console device activation request in the form of, for example, a Local Area Network (LAN) ping, from a remote server to alter the power level for a component in the console 102.

An application 260 comprising machine instructions is stored on hard disk drive 208. When console 102 is powered on, various portions of application 260 are loaded into RAM 206, and/or caches 210 and 212, for execution on CPU 200, wherein application 260 is one such example. Various applications can be stored on hard disk drive 208 for execution on CPU 200.

Gaming and media system 100 may be operated as a standalone system by simply connecting the system to audiovisual device 16 (FIG. 1), a television, a video projector, or other display device. In this standalone mode, gaming and media system 100 enables one or more players to play games, or enjoy digital media, e.g., by watching movies, or listening to music. However, with the integration of broadband connectivity made available through network interface 232, gaming and media system 100 may further be operated as a participant in a larger network gaming community.

FIG. 3B illustrates another embodiment of a computing environment that may be used in the target recognition, analysis, and tracking system. FIG. 3B illustrates an example of a suitable computing system environment 300 such as a personal computer. With reference to FIG. 3B, an exemplary system for implementing the invention includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3B illustrates operating system 334, application programs 335, other program modules 336, and program data 337.

The computer 310 may also include other removable/non-removable, volatile/nonvolatile computer storage media. By way of example only, FIG. 3B illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3B, provide storage of computer readable instructions, data structures, program modules and other data for the computer 310. In FIG. 3B, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 20 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 390.

In an embodiment, computer 310 may also include a microcontroller unit 254 as discussed in FIG. 3A to perform the intelligent power control of the various components of the computer 310. The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3B. The logical connections depicted in FIG. 3B include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3B illustrates remote application programs 385 as residing on memory device 381. It will be appreciated that the network connections shown are exemplary and other means of establishing a communications link between the computers may be used.

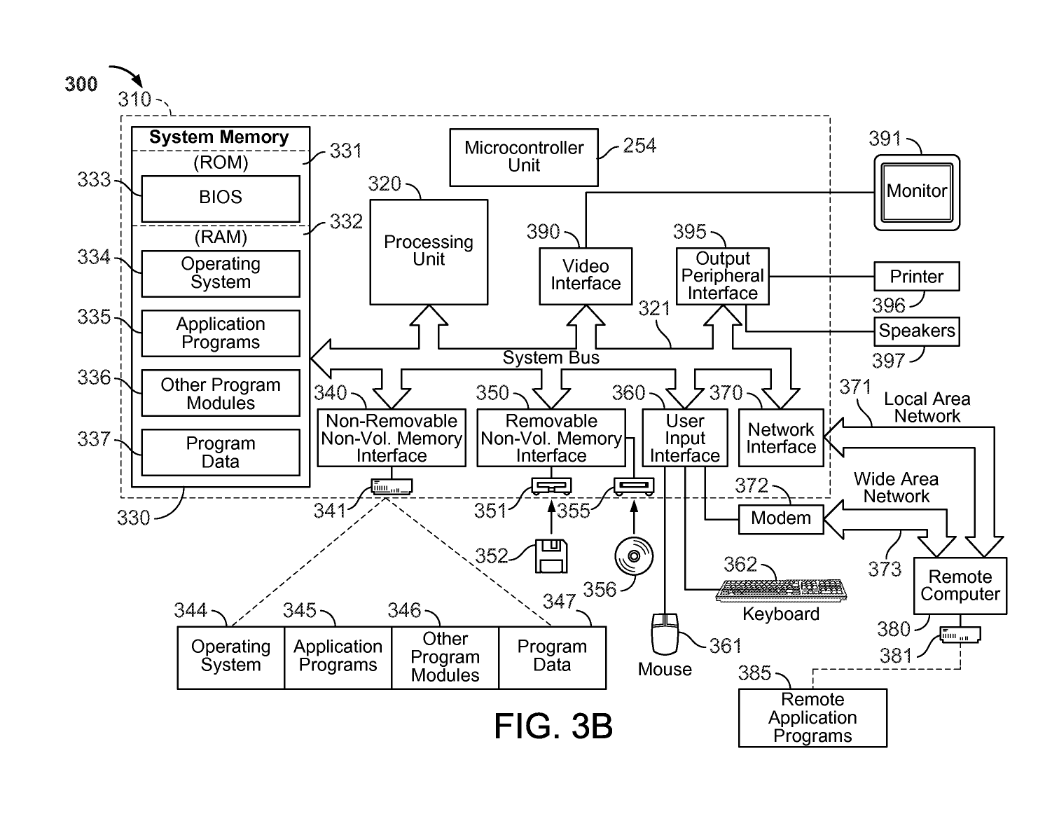

FIG. 4 illustrates an embodiment of a multimedia system that may utilize the present technology. The computing environment such as the computing environment 12, described above with respect to FIG. 3A, for example, may be an electronic device like a multimedia console 102 for executing a game or other application in the multimedia system 530. As illustrated, the multimedia system 530 may also include one or more other devices, such as, for example, a music player like a compact disc (CD) player 508, a video recorder and a videoplayer like a DVD/videocassette recorder (DVD/VCR) player 510, an audio/video (A/V) amplifier 512, a television (TV) 514 and a personal computer (PC) 516.

The devices (508-516) may be in communication with the computing environment 12 via a communication link 518, which may include a wired connection including, for example, a USB connection, a Firewire connection, an Ethernet cable connection, or the like and/or a wireless connection such as a wireless 802.11b, g, a, or n connection. In other embodiments, the devices (508-516) each include an HDMI interface and communicate over an HDMI wired (e.g. HDMI cable connection) or wireless connection 518. The HDMI connection 518 includes a standard consumer electronics channel (CEC) in which standardized codes for device commands can be transferred. The computing environment 12 may also include an A/V (audio/video) port 228 (shown in FIG. 3A) for transmission to the TV 514 or the PC 516. The A/V (audio/video) port, such as port, 228 may be configured for a communication coupling to a High Definition Multimedia Interface “HDMI” port on the TV 514 or the display monitor on the PC 516.

A capture device 20 may define an additional input device for the computing environment 12. It will be appreciated that the interconnections between the various devices (508-516), the computing environment 12 and the capture device 20 in the multimedia system 530 are exemplary and other means of establishing a communications link between the devices (508-516) may be used according to the requirements of the multimedia system 530. In an embodiment, system 530 may connect to a gaming network service 522 via a network 520 to enable interaction with a user on other systems and storage and retrieval of user data therefrom.

Consumer electronic devices which typically make up a multimedia system of audiovisual content output devices have develop commonly used or standardized command sets. In the embodiment of FIG. 2, these command sets may be stored in the device data store 42. A data packet may be formatted with a device identifier and a command code and any subfields which may apply.

Communication between the devices in the multimedia system 530 to perform the operations of the disclosed technology may in one implementation be performed using High Definition Multimedia Interface (HDMI), which is a compact audio/video interface for transmitting uncompressed digital data between electronic devices. As will be appreciated, HDMI supports, on a single cable, a number of TV or PC video formats, including standard, enhanced, and high-definition video, up to 8 channels of digital audio and a Consumer Electronics Control (CEC) connection. The Consumer Electronics Control (CEC) connection enables the HDMI devices to control each other and allows a user to operate multiple devices at the same time.

In one embodiment, the CEC of the HDMI standard is embodied as a single wire broadcast bus which couples audiovisual devices through standard HDMI cabling. There are automatic protocols for physical address and logical address discovery, arbitration, retransmission, broadcasting, and routing control. Message opcodes identify specific devices and general features (e.g. for power, signal routing, remote control pass-through, and on-screen display). In some embodiments using the HDMI (CEC), the commands used by the device controlling unit 540 may incorporate one or more commands used by the CEC to reduce the number of commands a user has to issue or provide more options. In other embodiments, the HDMI (CEC) bus may be implemented by wireless technology, some examples of which are Bluetooth and other IEEE 802.11 standards.

Some examples of command sets which may be used by the device controlling unit 540 in different embodiments are as follows for some examples of devices:

ON/OFF—Universal (all devices turned on/off)

DVR, DVD/VCR Player—Play, Rewind, Fast Forward, Menu, Scene Select, Next, Previous, On, Off, Pause, Eject, Stop, Record, etc.;

CD Player, Digital Music Player—Play, Rewind, Fast Forward, Menu, Track Select, Skip, Next, Previous, On, Off, Pause, Eject, Stop, Record, Mute, Repeat, Random, etc.;

Computer—On, Off, Internet connect, and other commands associated with a CD/DVD player or other digital media player as in the examples above; open file, close file, exit application, etc.

Television, Stereo—On, Off, Channel Up, Channel Down, Channel Number, Mute, scan (up or down), volume up, volume down, volume level, program guide or menu, etc.;

These example sets are not all inclusive. In some implementations, a command set may include a subset of these commands for a particular type of device, and may also include commands not listed here.

The method embodiments of FIGS. 5 through 10 are discussed for illustrative purposes with reference to the systems illustrated in FIGS. 2 and 4. Other system embodiments may use these method embodiments as well.

FIG. 5 illustrates an exemplary set of operations performed by the disclosed technology to automatically activate a computing environment 12 in a multimedia system 530 like that shown in FIG. 4, through user interaction. In step 399, a capture area associated with the computing environment 12 is periodically scanned to detect a user's presence in the capture area by one or more sensors communicatively coupled to the computing environment 12. As discussed in FIG. 2, for example, one or more passive sensors in the plurality of sensors 36 operating at a very low power level or at a standby power level may periodically scan the capture area associated with the computing environment to detect a user's presence. In step 400, a check is made to determine if a user's presence was detected. If a user's presence was not detected, then the sensors may continue to periodically scan the capture area to detect a user's presence as discussed in step 399. For example, a motion sensor may detect movement. If a user's presence was detected, then in step 402, data relating to a user interaction with the computing environment is received.

In step 404, a check is made to determine if the data relating to the user interaction is a physical action which corresponds to a user's intent to interact with the computing environment. The user interaction may include, for example, a gesture, voice input or both from the user. A user's intent to interact with the computing environment may be determined based on a variety of factors. For example, a user's movement towards the capture area of the computing environment 12 may indicate a higher probability of the user's intent to interact with the computing environment 12. On the other hand, the probability of a user's intent to interact with the computing environment 12 may be low if the user is generally in one location and appears to be very still. Or, for example, a user's quick movement across the capture area of the computing environment 12 or a user's movement away from the capture area may be indicative of a user's intent not to interact with the computing environment 12.

In another example, a user may raise his or her arm and wave at the capture device 20 to indicate intent to interact with the computing environment 12. Or, the user may utter a voice command such as “start” or “ready” or “turn on” to indicate intent to engage with the computing environment 12. The voice input may include spoken words, whistling, shouts and other utterances. Non-vocal sounds such as clapping the hands may also be detected by the capture device 20. For example, an audio capture device such as a microphone 30 coupled to the capture device 20 may optionally be used to detect a direction from which a sound is detected and correlate it with a detected location of the user to provide an even more reliable measure of the probability that the user intends to engage with the computing environment 12. In addition, the presence of voice data may be correlated with an increased probability that a user intends to engage with an electronic device. Moreover, the volume or loudness of the voice data may be correlated with an increased probability that a user intends to engage with a device. Also, speech can be detected so that commands such as “turn on device” “start” or “ready” indicate intent to engage with the device. A user's intent to engage with a device may also include detecting speech which indicates intent to engage with the device and/or detecting a voice volume which indicates intent to engage with the device.

In one embodiment, a user's intent to interact with the computing environment (e.g. 100, 12) may be detected based on audio inputs such as a clapping sound from the user, lightweight limited vocabulary speech recognition, and/or based on lightweight image processing performed by the capture device, such as, for example, a 1 HZ rate look for a user standing in front of the capture device or facing the capture device. For example, edge detection at a frame of once a second may indicate a human body. Whether the human is facing front or not may be determined based on color distinctions around the face region based on photographic image data. In another example, the determination of forward facing or not may be based on the location of body parts. The user recognition software 196 may also use pattern matching of image data of the detected user with a reference image to identify the user.

If it is determined in step 404, that the user intends to interact with the computing environment, then in step 408, the power level of the computing environment is set to a particular level to enable the user's interaction with the computing environment if the computing environment is not already at that level. If at step 404, it is determined that the user does not intend to interact with the computing environment, then, in step 406, the power level of the computing environment is retained at the current power level.

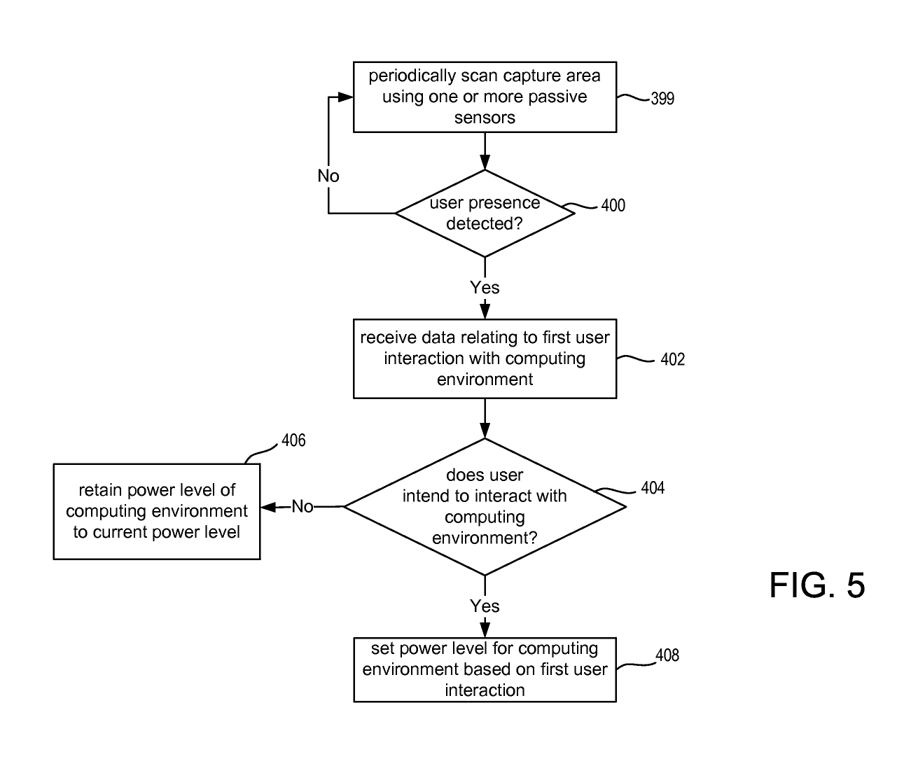

FIG. 6 is a flowchart of an embodiment of a method for a computing environment registering one or more devices a multimedia system for receiving commands. The example is discussed in the context of the system embodiments of FIGS. 2 and 4 for illustrative purposes. When a new device is added to the multimedia system 530, the device controlling unit 540 of the computing environment 12 in step 602 receives a message of a new device in the multimedia system over the communication link 518, and in step 604 creates a data set for the new device in the device data store 42. For example, a device identifier is assigned to the new device and used to index into its data set in the device data store 42. The device controlling unit in step 606 determines a device type for the new device from the message. For example, a header in the message may have a code indicating a CD Player 508 or a DVD/VCR Player 510. In step 608, the device controlling unit stores the device type for the new device in its data set in the device data store 42. New commands are determined for the new device from one or more messages received from the device in step 610, and the device controlling unit 540 stores the commands for the new device in its data set in the device data store 612.

Physical actions of a user represent the commands. In some embodiments, the physical actions corresponding to the set of commands for each device are pre-determined or pre-defined. In other examples, the user may define the physical actions or at least select from a list of those he or she wishes to identify with different commands. The device controlling unit 540 may cause a display of the electronic devices discovered in the multimedia system to be displayed on a screen 14 for a user in a set-up mode. Physical actions may be displayed or output as audio in the case of sounds for the user to practice for capture by the capture device 20, or the user may perform their own physical actions to be linked to the commands for one or more of the devices in the system 530.

Pre-defined physical gestures may be represented in filters 46. In the case of user defined gestures, the device controlling unit 540 tracks for which device and command the user is providing gesture input during a capture period (e.g. displays instructions to the user to perform between start and stop), and informs the gesture recognition engine 190 to generate a new filter 46 for the gesture to be captured during the capture period. The gesture recognition engine 190 generates a filter 46 for a new gesture and notifies the device controlling unit 540 via a message that it has completed generating the new filter 46 and an identifier for it. The device controlling unit 540 may then link the filter identifier to the command for the one or more applicable devices in the device data store 42. In one embodiment, the device data store 42 is a database which can be searched via a number of fields, some examples of which are a command identifier, device identifier, filter identifier and a user identifier. In some examples, a user defined gesture may be personal to an individual user. In other examples, the gesture may be used by other users as well to indicate a command.

Similarly, the sound recognition software 194 responds to the device controlling unit 540 request to make a sound file of the user practicing the sound during a time interval by generating and storing the sound file for the command and the applicable devices in the device data store 42. In some embodiments where voice speech input is a physical action or part of one, the sound recognition software 194 may look for trigger words independent of the order of speech. For example, “DVD, play”, “play the DVD player” or “play DVD” will all result in a play command being sent to the DVD player. In some embodiments, a combination of sound and gesture may be used in a physical action for a device command. For example, a gesture for a common command, e.g. on, off, play, may be made and a device name spoken, and vice versa, a common command spoken and a gesture made to indicate the device.

The physical action sound file or filter may also be associated with a particular user in the device data store 42. This information may also be used by the user recognition software 196 and/or the device controlling unit 540 to identify a user providing commands. This information may be used for providing user preferences for operation of a device based on the received command as described below.

In some examples, a physical action, may be assigned for each device, and then a physical action identified for each command of the device. In another example, physical actions may be associated with common commands (e.g. on, off, play, volume up) and either a physical action (e.g. gesture or sound identification like aspoken name of device or a sound like a whistle or clapping, or a combination of gesture and sound) associated with the specific device or a set of devices. For example, a user may say “OFF” and perform a gesture associated with the set of all devices linked in the multimedia system for a universal OFF command

There may also be a physical action, pre-defined or defined by the user, indicating to turn on or off all of the devices in the multimedia system. The devices 508-516 may be turned off, and the computing environment may stay in a standby or sleep mode from which it transitions to an active mode upon detecting user presence and an indication of user intent to interact with the system. An example of such a command is a gesture to turn on the computing environment.

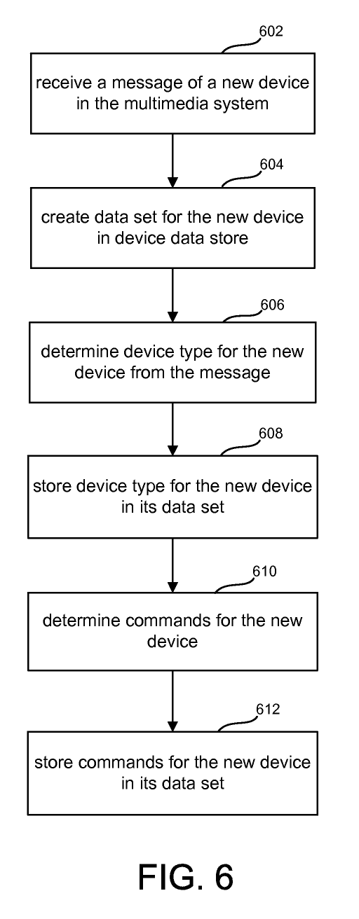

FIG. 7 is a flowchart of an embodiment of a method for controlling one or more electronic devices in a multimedia system using a natural user interface. In step 702, one or more physical actions of a user are sensed by a natural user interface. In the example of FIG. 2, the capture device 20 with the computing environment 12 and its software recognition components, 190, 194 and 196 operate as a natural user interface. The image component 22 may sense a physical action of a gesture. The microphone 30 may sense sounds or voice inputs from a user. For example, the user may utter a command such as “turn on TV” to indicate intent to engage with the TV 514 in the multimedia system 530. The sensors 36 may sense a presence or movement which is represented as data assisting in the gesture recognition processing. The sensed physical inputs to the one or more of these sensing devices 30, 22, 36 are converted to electrical signals which are formatted and stored as processor readable data representing the one or more physical actions. For example, the image component 22 converts the light data (e.g visible and infrared) to digital data as the microphone 30 or the sensors 36 convert sound, vibration, etc. to digital data which processor 32 can read and transfer to the computing environment for processing by its software recognition components 190, 194 and 196.

In the illustrative example of FIG. 2, the computing environment 12 acts as a first electronic device identifying commands for the other electronic devices 45 in the multimedia system. In other examples, another type of device including components of or coupled to a natural user interface may act as the first electronic device. In step 704, software executing in the computing environment 12 such as the sound 194 and gesture recognition software components 190 identify a device command from the one or more physical actions for at least one other device and notify the device controlling unit 540.

Optionally, in step 706, the recognition software components 190, 194 and 196 may identify one or more detected users including the user making the command. For detected users for which user profile data does not exist, as mentioned in previous examples, the user recognition software 196 can store sound or image data as identifying data and generate a user identifier which the sound 194 and/or gesture recognition 190 components can associate with commands. The identifying data stored in user profile data 40 by the user software 196 may be retrieved later in the command history discussed below. The sound or image data may be captured of the unidentified user in a capture area of the capture device. For a camera, the capture area may be a field of view. For a microphone, the capture area may be a distance from the microphone. The user recognition software 196 sends a message to the device controlling unit 540 identifying the detected users. In some examples, the gesture recognition software 190 or the sound recognition software 194 sends data indicating a command has been made and an identifier of the user who made the command to to the device controlling unit 540 which can use the user identifier to access user preferences, user priority and other user related data as may be stored in the user profile data 40, the device data 42 or both. The user recognition software 196 may also send update messages when a detected user has left the capture area indicating the time the user left. For example, the software executing in the capture device 20 can notify the user recognition software 196 when there is no more data for a skeletal model, or edge detection indicates a human form is no longer present, the user recognition software 196 can update the detected user status by removing the user associated with the model or human form no longer present. Additionally, the user recognition software 196 can perform its recognition techniques when a command is made, and notify the device controlling unit 540 of who was present at the time of the command in the capture area associated with the computing environment 12.

In some embodiments, a user during set-up of the device commands can store a priority scheme of users for controlling the devices in the multimedia system by interacting with a display interface displayed by the device controlling unit 540 which allows a user to input the identities of users in an order of priority. In a natural user interface where the user is the controller or remote, this priority scheme can prevent fighting for the remote. For example, a parent may set the priority scheme. Optionally, one or more of the recognition software components 190, 194, 196 identifies the user who performed the physical action, and the device controlling unit 540 determines in step 708 whether the user who performed the action has priority over other detected users. If not, the device controlling unit 540 determines in step 712 whether the command is contradictory to a command of a user having higher priority. For example, if the command is from a child to turn on the stereo which contradicts a standing command of a parent of no stereo, an “on” command to the stereo is not sent, but optionally, the device command history data store may be updated with a data set for the command for the stereo including a time record of date and time, the user who requested the command, its execution status, and command type. In the example of the child's command, the execution status may indicate the command to the stereo was not sent.

If the user has priority over other detected users or the command is not contradictory to a command of a user with higher priority, the device controlling unit 540 sends the command in step 710 to the at least one other electronic device. Optionally, the device controlling unit 540 updates the device command history data in the device data store 42 with data such as the device, the command type, time, date, identifying data for the detected users, identifying data for the user who made the command, and execution status for the at least one device.

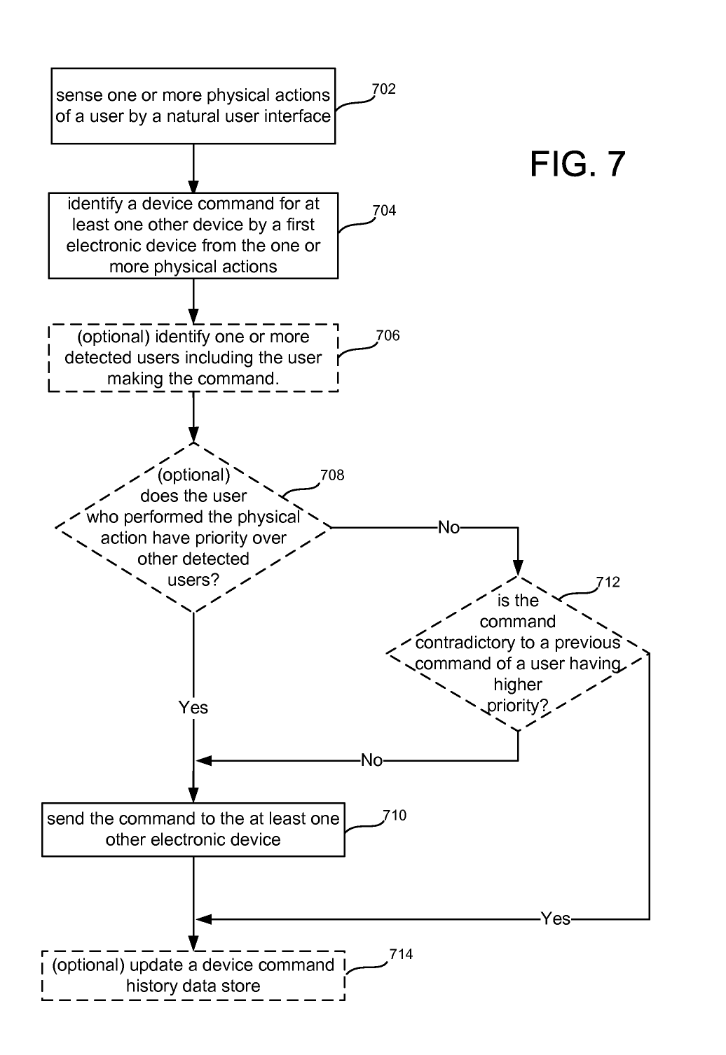

FIG. 8 is a flowchart of an embodiment of a method for determining whether a second device is used to process a command for a first device. FIG. 8 may be an implementation of step 710 or encompass separate processing. In step 716, the device controlling unit 540 determines whether the device receiving the command relies on at least one other device which supports processing of the command. For example, a second device relies on a third device for input or output of content processed by the command As mentioned above, when a user commands “Play” for a DVD player or a DVR, the output of the movie or other video data is displayed on a television or other display device. In one example, the device controlling unit 540 reads a lookup table stored in the device data store 42 which indicates supporting devices for input and output of content for a device for a particular command. In another example, the A/V amplifier 512 may embody audio speakers. The lookup table of supporting devices for the A/V amplifier stores as content input devices the CD Player 508, the DVD/VCR player 510, the television 514, the computing environment 12, the personal computer 516 or the gaming network service 522. Upon determining that the device receiving the command does rely on at least one other device for support of processing, e.g. provide content input or output, a power access path, or a network connection, the device controlling unit 540 sends one or more commands in step 718 to the at least one other device to support processing of the command by the device receiving the command. For example, these one or more commands cause the at least one other device to turn on if not on already and receive or transmit content on a port accessible by the device it is supporting in the command. If the device receiving the command does not rely on supporting devices for the command, the device controlling unit 540 returns control in step 720 until another command is identified by the natural user interface.

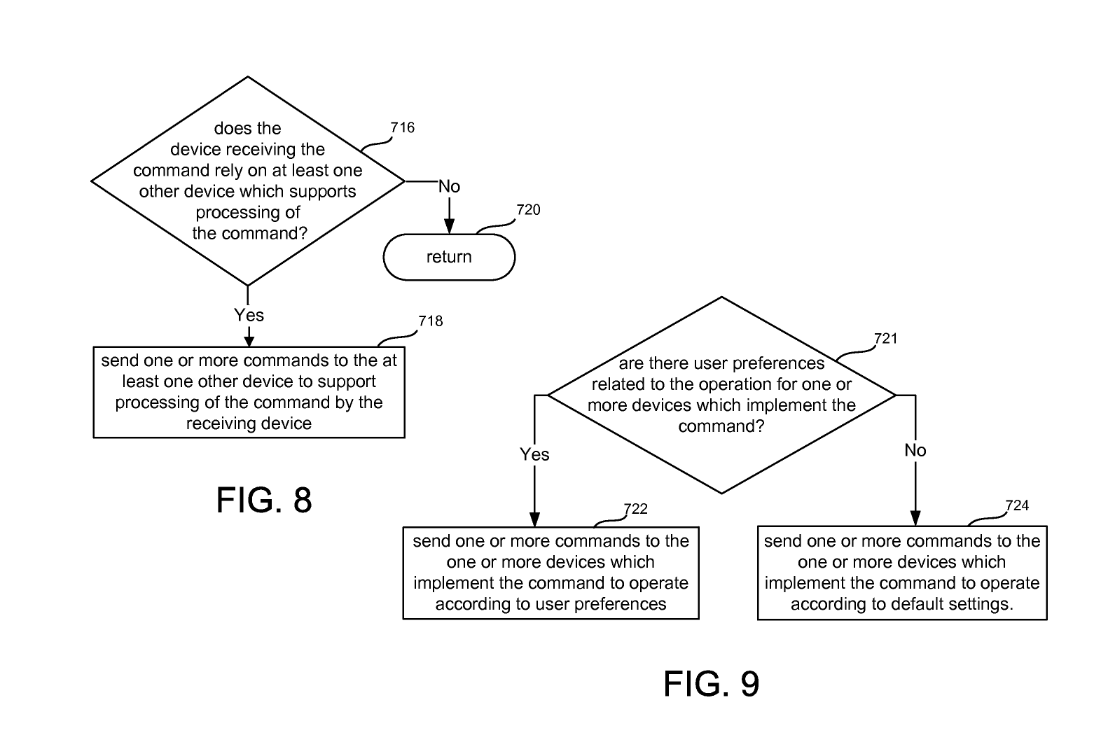

FIG. 9 is a flowchart of a method for executing a command in accordance with user preferences. FIG. 9 may be an implementation of step 710 or encompass separate processing. In step 721, the device controlling unit 540 determines whether there are preferences related to the operation for one or more devices which implement the command. For example, the user may have indicated to turn on the stereo. The command packet may allow sub-fields for a channel number or volume level. The user may have a preferred channel and volume level stored in his or her user profile data 40 linked to a data set for the stereo in the device data store 42.

If there are not user preferences indicated, the device controlling unit 540 in step 724 sends one or more commands to the one or more devices which implement the command to operate according to default settings. If there are user preferences, in step 722 the device controlling unit 540 sends the one or more commands to the one or more devices which implement the command to operate according to user preferences. The user preferences may be applied for the user who gave the command and/or a detected user who has not provided the command. In one example mentioned above, one user may prefer the audio to be output through the A/V Amplifier 512 when watching content on the television, while another does not. If the user priority scheme is implemented, the user preferences of the priority user are implemented. If no scheme is in place, but user preferences exist for both users, the preferences of the commanding user may be implemented.

In some embodiment, a user may use a hand-held remote controller or other input device 48, e.g. a game controller, instead of a physical action to provide commands to the computing environment 12 and still take advantage of the user priority processing, user preferences processing and review of the device command history. The natural user interface of a capture device 20 and a computing environment 12 may still identify users based on their voices and image data and login credentials if provided. This identification data may still be used to provide the processing of FIGS. 8, 9 and 10.

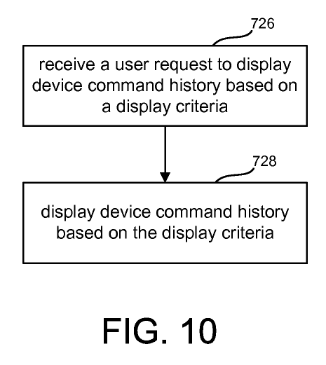

FIG. 10 is a flowchart of an embodiment of a method for requesting a display of a command history. The device controlling unit 540 receives in step 726 a user request to display device command history based on a display criteria, and in step 728, the device controlling unit 540 displays the device command history based on display criteria. The device command history may be accessed and displayed remotely. For example, a parent may remotely log into the gaming network service 522 and display the command history on a remote display like her mobile device. Some examples of display criteria may include command type, device, time or date, user giving commands, and may also give users detected during the operation of devices in a time period even if the users gave no commands. Data of one or more physical characteristics of an unidentified user may be stored as identifying data which may be retrieved with the command history.

In certain situations, a user may also desire to interact with the computing environment 12 and the other devices (508-516) in the multimedia system 530 via the network 520 shown in FIG. 4. Accordingly, the computing environment 12 in the multimedia system 530 may also receive a voice input or gesture input from a user connected to the gaming network service 522, via the network 520, indicating intent to interact with the computing environment 12. In another example, the input may be a data command selected remotely from a remote display of commands or typed in using an input device like a keyboard, touchscreen or mouse. The power level of the computing environment 12 may be altered and the computing environment 12 may be activated for the user even when the user is outside the capture area of the computing environment 12. Additionally, the computing environment may also issue other commands, for example commands turning off the power levels of one or more of the devices (508-516), based on the voice input or other remote commands from the user.

The example computer systems illustrated in the figures above include examples of computer readable storage media. Computer readable storage media are also processor readable storage media. Such media may include volatile and nonvolatile, removable and non-removable media implemented in any method or technology for storage of information such as computer readable instructions, data structures, program modules or other data. Computer storage media includes, but is not limited to, RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other medium which can be used to store the desired information and which can accessed by a computer.

The technology may be embodied in other specific forms without departing from the spirit or essential characteristics thereof. Likewise, the particular naming and division of applications, modules, routines, features, attributes, methodologies and other aspects are not mandatory, and the mechanisms that implement the technology or its features may have different names, divisions and/or formats. Furthermore, as will be apparent to one of ordinary skill in the relevant art, the applications, modules, routines, features, attributes, methodologies and other aspects of the embodiments disclosed can be implemented as software, hardware, firmware or any combination of the three. Of course, wherever a component, an example of which is an application, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of programming

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method for controlling one or more electronic devices in a multimedia system using a natural user interface of another device comprising:
sensing one or more physical actions of a user by the natural user interface;
identifying a device command for at least one other device by a first electronic device from data representing the one or more physical actions; and
the first device sending the command to the at least one other electronic device.

2. The computer implemented method of claim 1, wherein:
the first device sending the command to the at least one other electronic device comprises sending the command to a second device and sending another command to a third device which supports processing of the command by the second device.

3. The computer implemented method of claim 1, wherein:
the first device sending the command to the at least one other electronic device further comprises sending one or more commands to the one or more devices which implement the command to operate according to user preferences.

4. The computer implemented method of claim 1, further comprising:
detecting the user's presence in a capture area of a capture device of the natural user interface;
determining whether the user intends to interact with the first device; and
responsive to determining the user intends to interact with the first device, setting a power level for the first device for user interaction processing.

5. The computer implemented method of claim 1, wherein the physical action comprises at least one of a gesture or a voice input.

6. The computer implemented method of claim 1, further comprising:
identifying one or more users detected by the natural user interface including the user making the command.

7. The computer implemented method of claim 6, further comprising:
storing data of one or more physical characteristics as identifying data for unidentified users detected by the natural user interface.

8. The computer implemented method of claim 7, further comprising:
storing a device history of identified commands including for each command the device commanded, a time and date of the command, and identifying data of one or more users detected by the natural user interface when the command was made.

9. A multimedia system, comprising:
a capture device for capturing data of a physical action of a user indicating a command to one or more electronic devices in the multimedia system; and
a computing environment comprising:
a processor and a memory and being in communication with the capture device to receive data indicating the command and being in communication with one or more other electronic devices in the multimedia system,
software executable by the processor for determining for which of the one or more other devices the command is applicable and sending the command to the applicable device, and
user recognition software for identifying a user based on data representing one or more physical characteristics captured by the capture device, the data representing one or more physical characteristics comprising at least one of sound data or image data.

10. The multimedia system of claim 9, wherein one or more of the devices comprise at least one of a music player, a video recorder, a video player, an audio/video (A/V) amplifier, a television (TV) and a personal computer (PC).

11. The multimedia system of claim 9, wherein the capture device is an audio capture device for capturing data of sound input as a physical action.

12. The multimedia system of claim 9, wherein the capture device is an image capture device for capturing image data of a gesture as a physical action.

13. The multimedia system of claim 9, wherein the computing environment further comprises gesture recognition software stored in memory and which when executed by the processor identifies the command based on the physical action including a gesture.

14. The multimedia system of claim 9, wherein the computing environment further comprises sound recognition software stored in memory and which when executed by the processor identifies the command based on the physical action including a sound input.

15. The multimedia system of claim 9 further comprising one or more sensors communicatively coupled to the capture device for detecting a user's presence in a capture area associated with the computing environment.

16. The multimedia system of claim 9 wherein the computing environment is in communication with the one or more other devices in the multimedia system via an HDMI connection including a Consumer Electronics Channel (CEC).

17. The multimedia system of claim 16, wherein the HDMI connection comprises at least one of:
a HDMI wired connection; or
a HDMI wireless connection.

18. A computer readable storage medium having stored thereon instructions for causing one or more processors to perform a computer implemented method for controlling one or more electronic devices in a multimedia system using a natural user interface, the method comprising:
receiving a device command by a first electronic device for at least one other device in the multimedia system;
detecting one or more users in data captured via the natural user interface;
identifying one or more of the detected users including the user making the command;
determining whether the user making the command has priority over other detected users; and
responsive to the user making the command having priority over other detected users, sending the command to the at least one other electronic device.

19. The computer readable storage medium of claim 18, wherein the method further comprises:
responsive to the user making the command lacking priority over other detected users, determining whether the command contradicts a previous command of a user having a higher priority; and
responsive to the command not contradicting the previous command, sending the command to the at least one other electronic device.

20. The computer readable storage medium of claim 18, wherein the method further comprises:
storing the command and a time record for the command indicating a date and time associated with the command, the device for the command, the user who made the command, and any other detected users in a device command history; and
responsive to user input requesting displaying of the device command history of one or more commands based on a display criteria, displaying the command history of one or more commands based on the display criteria.
